(19) United States
(12) Patent Application Publication
(10) Pub. No.: US 2025/0155609 A1
(43) Pub. Date: May 15, 2025

(54) OPTICAL MODULE

(71) Applicant: Lextar Electronics Corporation, Hsinchu City (TW)

(72) Inventors: Kai-Hung CHENG, Hsinchu City (TW); Ku-Cheng LIN, Hsinchu City (TW); Chun-Min LIN, Hsinchu City (TW); Wei-Yi HSU, Hsinchu City (TW)

(21) Appl. No.: 18/938,136

(22) Filed: Nov. 5, 2024

(30) Foreign Application Priority Data
Nov. 9, 2023 (CN) 202311490462.1

(51) Int. Cl. G02B 3/02; B60K 28/06; B60W 40/08; G02B 3/00; G02B 7/02; G06V 20/59

(52) U.S. Cl. CPC G02B 3/02; B60W 40/08; G02B 7/025; B60K 28/066; B60W 2040/0827; G02B 2003/0093; G06V 20/597

(57) ABSTRACT

An optical module is provided. The optical module includes a resin package, a lens and a light emitting element. The resin package has a receiving groove. The lens is disposed on the resin package, and the lens includes a light emitting surface, a light entering surface, and a central axis, wherein the light entering surface has an asymmetric structure. The light emitting element is disposed in the receiving groove, wherein the light emitting element is disposed deviated from the central axis of the lens.

### CROSS REFERENCE TO RELATED APPLICATIONS

This Application claims priority of China Patent Application No. 202311490462.1, filed on Nov. 9, 2023, the entirety of which is incorporated by reference herein.

### BACKGROUND OF THE DISCLOSURE

### Field of the Disclosure

The present disclosure relates to an optical module, and in particular to an optical module with a lens with an asymmetric structure.

### Description of the Related Art

There is a problem with the driving monitoring system (DMS) at present. The monitoring quality is poor under weak light, which leads to misjudgment, so it is necessary to supplement the light in the car. FIG. 1A is a schematic view of a traditional light emitting diode package, and FIG. 1B is the light intensity distribution curve thereof. In FIG. 1B, the light emitting angle of the traditional light emitting diode package is about 120 degrees to 140 degrees, and the energy of the light is not concentrated on the human face, which results in energy waste.

FIG. 2A is a schematic view of an LED package with a lens. FIG. 2B is a light intensity distribution curve of an LED package with a conventional lens 300, which only has the function of reducing the divergence angle, but the light pattern is still circular, and it has no effect of deflecting the angle of light. Therefore, when the fatigue driving monitoring module is disposed on the A-pillar, it may cause uneven fill light.

### BRIEF SUMMARY OF THE DISCLOSURE

Some embodiments of the present disclosure provide an optical module. The optical module includes a resin package, a lens, and a light emitting element. The resin package has a receiving groove. The lens is disposed on the resin package, and the lens includes a light emitting surface, a light entering surface, and a central axis, wherein the light entering surface has an asymmetric structure. The light emitting element is disposed in the receiving groove, and the light emitting element is disposed deviating from the central axis of the lens.

The above does not represent every embodiment or every aspect of the present disclosure, but only provides examples of some novel aspects and features described herein. When combined with the accompanying drawings and the appended claims, the above features and advantages of the present disclosure and other features and advantages will become apparent from the following detailed description of representative embodiments and methods for implementing the present disclosure.

### BRIEF DESCRIPTION OF THE DRAWINGS

Through the following detailed description in conjunction with the attached drawings, the viewpoints of the embodiments of the present disclosure may be better understood. It is worth noting That is, according to standard practices in the industry, some components may not be drawn to scale. In fact, the sizes of different components may be increased or reduced in order to clearly describe.

FIG. 1A is a schematic view of a conventional light emitting diode package;

FIG. 1B is a light intensity distribution curve of a conventional light emitting diode;

FIG. 2A is a schematic view of a light emitting diode package having a lens;

FIG. 2B is a light intensity distribution curve of a light emitting diode package having a lens;

FIG. 3A is a schematic view of a fatigue driving monitoring module according to some embodiments of the present disclosure;

FIG. 3B is a side view of a fatigue driving monitoring module according to some embodiments of the present disclosure;

FIG. 4 is a schematic view of a fatigue driving monitoring module placed in a vehicle;

FIG. 5 is a block diagram of a characteristic functional structure of a fatigue driving monitoring module according to some embodiments of the present disclosure;

FIG. 6 is a diagram showing the distribution between blink frequency and sleepiness intensity according to some embodiments of the present disclosure;

FIG. 7 is a graph showing eyelid closure percentages according to some embodiments of the present disclosure;

FIG. 8 is a perspective view of an optical module according to some embodiments of the present disclosure;

FIG. 9A is a cross-sectional schematic view of an optical module according to some embodiments of the present disclosure;

FIG. 9B is a cross-sectional schematic view of an optical module according to some embodiments of the present disclosure;

FIG. 10 is a perspective top view of an asymmetric structure according to some embodiments of the present disclosure;

FIG. 11 is a top view of the external structure of a lens according to some embodiments of the present disclosure;

FIG. 12 is a side view of the external structure of a lens according to some embodiments of the present disclosure;

FIG. 13 is a light distribution curve of a general light source;

FIG. 14A is a schematic view of the structure of comparative example 1;

FIG. 14B is a light distribution curve of comparative example 1;

FIG. 14C-1 is an illumination distribution diagram of comparative example 1;

FIG. 14C-2 is a diagram showing the illumination distribution in the X-axis direction of comparative example 1;

FIG. 14C-3 is a diagram showing the illuminance distribution in the Y-axis direction of comparative example 1;

FIG. 14C-4 is a light angle distribution diagram of comparative example 1;

FIG. 14D is a schematic view showing the relationship between the illumination distribution diagram of comparative example 1 and the facial illumination diagram;

FIG. 15A is a schematic view of the structure of comparative example 2;

FIG. 15B is a light distribution curve of comparative example 2;

FIG. 15C-1 is an illumination distribution diagram of comparative example 2;

FIG. 15C-2 is a diagram showing the illumination distribution in the X-axis direction of comparative example 2;

FIG. 15C-3 is a diagram showing the illuminance distribution in the Y-axis direction of comparative example 2;

FIG. 15C-4 is a light angle distribution diagram of comparative example 2;

FIG. 15D is a schematic view showing the relationship between the illumination distribution diagram of comparative example 2 and the facial illumination diagram;

FIG. 16A is a light distribution curve according to some embodiments of the present disclosure;

FIG. 16B-1 is an illumination distribution diagram of the present disclosure;

FIG. 16B-2 is an illumination distribution diagram of the present disclosure in the X-axis direction;

FIG. 16B-3 is a diagram showing the illuminance distribution in the Y-axis direction of comparative example 1;

FIG. 16B-4 is a light angle distribution diagram of the present disclosure;

FIG. 16C is a schematic view showing the relationship between the illumination distribution diagram and the facial illumination diagram according to some embodiments of the present disclosure.

### DETAILED DESCRIPTION OF THE DISCLOSURE

The following disclosure provides different embodiments for implementing different components in the provided packaging structure. Specific examples of each component and its configuration are described below to simplify the embodiments of the present disclosure, but are certainly not intended to limit the present disclosure. For example, if the description mentions that a first component is formed on a second component, it may include an embodiment in which the first component is in direct contact with the second component, and it may also include an embodiment in which an additional component is formed between the first component and the second component so that the first component are not in direct contact with the second component. In addition, the present disclosure may repeat numerals and/or characters in different embodiments or examples. Such repetition is for simplicity and clarity, and is not used to indicate the relationship between the different embodiments and/or examples discussed.

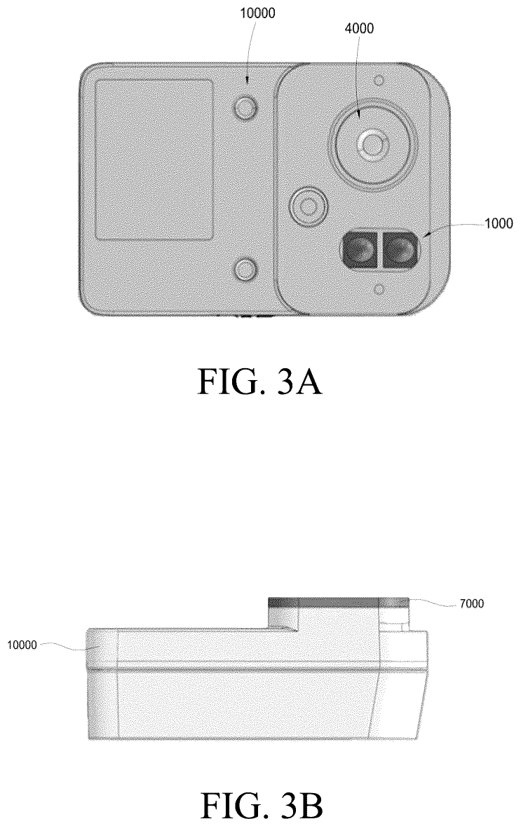

The present disclosure provides a fatigue driving monitoring module 10000. FIG. 3A is a schematic view of a fatigue driving monitoring module 10000 according to some embodiments of the present disclosure. The fatigue driving monitoring module 10000 includes an image capture unit 4000, an optical module 1000 and a calculation unit 5000 (not shown). The fatigue driving monitoring module 10000 may detect whether the driver is fatigued through the image capture unit 4000, the optical module 1000 and the calculation unit 5000 (not shown). The image capture unit 4000 may be a camera sensor, such as a charge-coupled device (CCD) or a Complementary Metal-Oxide-Semiconductor (CMOS) photosensitive element. The optical module 1000 includes an infrared diode.

In some embodiments, the wavelength of the infrared diode ranges from 830 nanometers to 950 nanometers. In some embodiments, the wavelength of the infrared diode may be 940 nanometers. In some embodiments, the wavelength of the infrared diode may be 850 nanometers.

In FIG. 3B, CMOS is a side view of a fatigue driving monitoring module according to some embodiments of the present disclosure. The fatigue driving monitoring module 10000 further includes a protective element 7000 disposed around the image capture unit 4000 and the optical module 1000, and the protective element 7000 can protect the image capture unit 4000 and the optical module 1000. The protective element 7000 may be also used to prevent dust. The protective element 7000 may be glass or polymethyl methacrylate (PMMA).

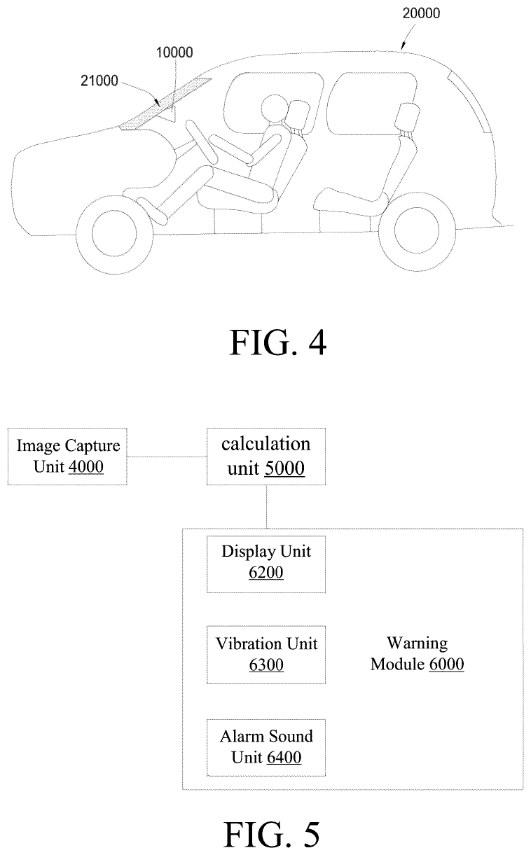

FIG. 4 is a schematic view of a fatigue driving monitoring module 10000 placed in a vehicle 20000. The fatigue driving monitoring module 10000 may be placed at the A-pillar 21000 of the vehicle 20000. The fatigue driving monitoring module 10000 has an optical module 1000 for providing lights.

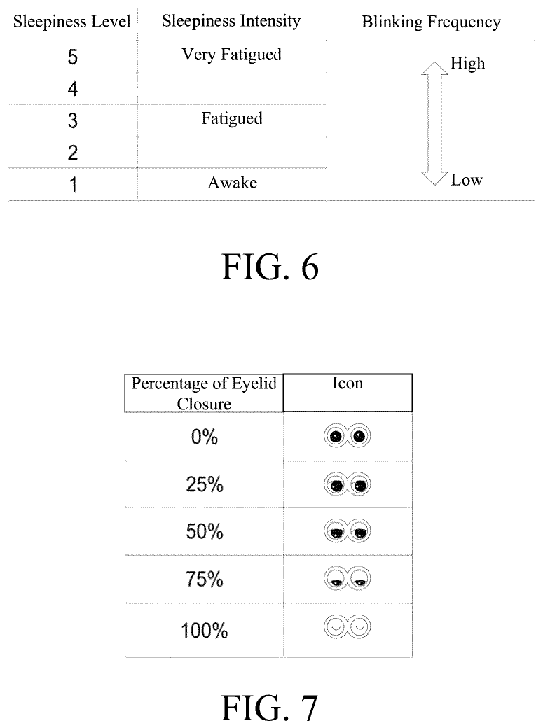

FIG. 5 is a block diagram of the characteristic functional structure of the fatigue driving monitoring module 10000. When the image capture unit 4000 captures the driving image, the optical module 1000 performs to fill the light. In conjunction with the data of the blinking frequency and sleepiness intensity distribution relationship diagram of FIG. 6 or the eyelid closure percentage diagram of FIG. 7, the calculation unit 5000 uses an algorithm to analyze the driver's fatigue state to find out whether the driver falls asleep during driving, so the calculation unit 5000 may obtain the driver's fatigue state data or sleepiness level. The calculation unit 5000 may be a central processing unit (CPU). The calculation unit 5000 outputs the driver's fatigue state data or sleepiness level information to the warning module 6000 to notify the driver or passengers. The warning module 6000 may include a display unit 6200, a vibration unit 6300, and an alarm sound unit 6400. In some embodiments, the display unit 6200 converts the obtained fatigue status data or sleepiness level information into an image or text so that the driver or passenger may see the driver's fatigue status data or sleepiness level. If the sleepiness level reaches 3-5 (as shown in FIG. 6), the driver is reminded to stop driving or let the passenger drive instead. The display unit 6200 may be a liquid crystal panel or a micro light emitting diode display. The display unit 6200 may be a smart phone or a tablet computer. In some embodiments, the calculation unit 5000 outputs the driver's fatigue status data or sleepiness level information to the vibration unit 6300 of the warning module 6000. If the sleepiness level reaches 3-5 (as shown in FIG. 6), the vibration unit 6300 can start to vibrate the steering wheel or the driver's seat. In some embodiments, the vibration unit 6300 gradually increases the vibration intensity of the steering wheel or the driver's seat to remind the driver to stay awake, stop driving or let the passenger drive instead. In some embodiments, the higher the sleepiness level, the stronger the vibration intensity of the steering wheel or the driver's seat. In some embodiments, the calculation unit 5000 outputs the driver's fatigue state data or sleepiness level information to the alarm sound unit 6400 of the warning module 6000, and the alarm sound unit 6400 emits an alarm to remind the driver to stay awake, stop driving or let the passenger drive instead. In some embodiments, the higher the sleepiness level, the louder the alarm is.

FIG. 6 is the distribution between blink frequency and sleepiness intensity. In some embodiments, when the driver is in a fatigued state, the blinking frequency and the time required for blinking can change. In addition, when the driver's fatigue level increases, the driver's eye closing time can increase, thus affecting the driver's driving performance. When the driver's fatigue level increases, the driver's blinking frequency can increase, thus affecting the driver's driving performance. The sleepiness level is divided into levels 1 to 5. When the blinking frequency is the lowest, it shows that the driver's sleepiness intensity is the lowest, and the sleepiness level is the first level. When the blinking frequency is the highest, it shows that the driver's sleepiness intensity is the highest, the sleepiness level is the fifth level, and the driver's fatigue level is the highest. When the calculation unit 5000 uses an algorithm to calculate that the driver's blinking frequency is high, it may be obtained that the driver's fatigue level is high, and a warning message is further issued.

FIG. 7 is a diagram of eyelid closure percentage. In some embodiments, the percentage of eyelid closure (PERCLOS) is used to analyze the driver's fatigue state. When the eyelid closure percentage exceeds 75% or 80%, it indicates that the driver is in a fatigue state.

In some embodiments, the optical module 1000 of the fatigue driving monitoring module 10000 includes an infrared diode. When the brightness in the car is insufficient, when the camera in the car captures the image of the driver, the optical module 1000 of the fatigue driving monitoring module 10000 may be used for filling light, and the driver's state may be analyzed more accurately. In some embodiments, the optical module 1000 includes an infrared diode for filling light. Since the driver cannot see infrared rays, when the infrared diode fills light, it does not affect the driver's sight.

The present disclosure provides an optical module 1000. The optical module 1000 may be used as a light source of a fatigue driving monitoring module 10000.

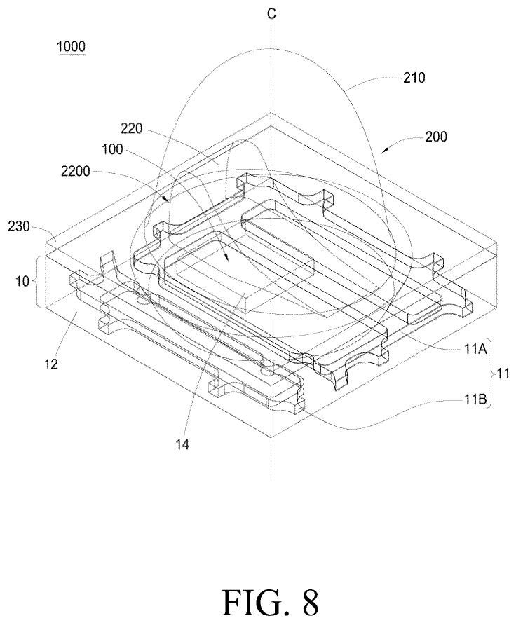

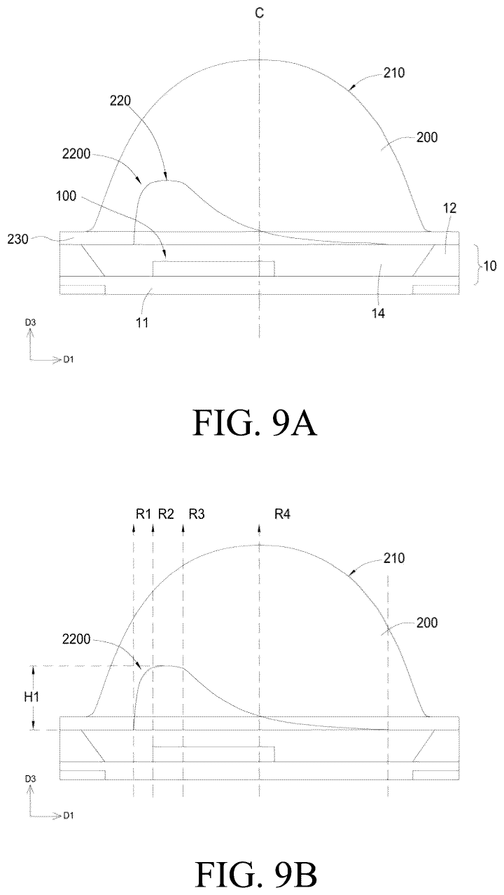

Referring to FIG. 8 and FIG. 9A, FIG. 8 is a perspective view of an optical module according to some embodiments of the present disclosure, and FIG. 9A is a cross-sectional schematic view of an optical module according to some embodiments of the present disclosure. The optical module 1000 includes a resin package 10, a lens 200 and a light emitting element 100. The resin package 10 has a lead frame 11 and a resin portion 12. The lead frame 11 includes a positive lead frame 11A and a negative lead frame 11B. The resin portion 12 forms a receiving groove 14. The light emitting element 100 is disposed in the receiving groove 14 and is disposed on the lead frame 11 and electrically connected to the lead frame 11. The light emitting element 100 has a first electrode (not shown) electrically connected to the positive lead frame 11A, and the light emitting element 100 has a second electrode (not shown) electrically connected to the negative lead frame 11B. The light emitting element 100 may be a vertical light emitting diode, a flip-chip light emitting diode or a horizontal light emitting diode. In some embodiments, the light emitting element 100 is a vertical light emitting diode, the first electrode is electrically connected to the positive lead frame 11A, and the second electrode is electrically connected to the negative lead frame 11B through a wire (not shown).

Referring to FIG. 8 and FIG. 9A, the lens 200 is disposed on the resin portion 12 of the resin package 10, and the lens 200 includes a light emitting surface 210, a light entering surface 220, a central axis C, and a lens base 230. The light entering surface 220 has an asymmetric structure 2200. The light emitting element 100 is disposed to be deviated from the central axis C of the lens 200. In some embodiments, there is an air gap between the light entering surface 220 and the light emitting element 100.

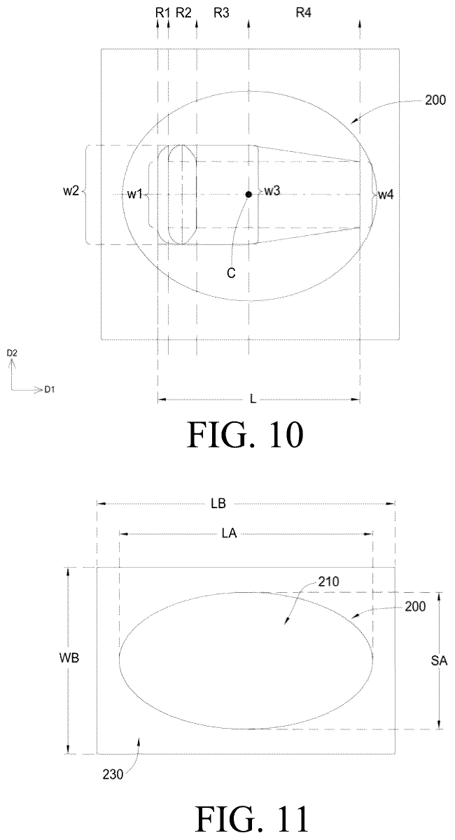

Referring to FIG. 9B and FIG. 10, FIG. 9B is a cross-sectional schematic view of an optical module according to some embodiments of the present disclosure, wherein the asymmetric structure 2200 includes a first region R1, a second region R2, a third region R3, and a fourth region R4. FIG. 10 is a top perspective view of the asymmetric structure of the lens 200 according to some embodiments of the present disclosure, wherein the asymmetric structure 2200 includes a first region R1, a second region R2, a third region R3, and a fourth region R4.

FIG. 9B is a cross-sectional schematic view of an optical module according to some embodiments of the present disclosure. From the cross-sectional schematic view, in some embodiments, the asymmetric structure 2200 has a first curvature in the first region R1, a second curvature in the second region R2, a third curvature in the third region R3, and a fourth curvature in the fourth region R4. When the third region R3 is in contact with the central axis C, it enters the fourth region R4.

Referring to FIG. 9B, in some embodiments, the first curvature is greater than the third curvature, the third curvature is greater than the fourth curvature, and the fourth curvature is greater than the second curvature.

Referring to FIG. 9B, in some embodiments, in the first region R1, the asymmetric structure 2200 is a convex surface; in the second region R2, the asymmetric structure 2200 is a convex surface; in the third region R3, the asymmetric structure 2200 is a concave surface; in the fourth region R4, the asymmetric structure 2200 is a concave surface.

Referring to FIG. 9B, in some embodiments, along the first direction, the protrusion height of the asymmetric structure 2200 in the third direction is non-uniform.

Referring to FIG. 9B, in some embodiments, along the first direction, in the first region R1, the protrusion height of the asymmetric structure in the third direction gradually increases; in the second region R2, the protrusion height of the asymmetric structure 2200 in the third direction still gradually increases, but the slope of the height increase is lower than that of the first region R1, and in the middle position of the second region R2, the protrusion height of the asymmetric structure 2200 in the third direction reaches the maximum height H1 of the asymmetric structure; in the third region R3, the protrusion height of the asymmetric structure 2200 in the third direction gradually decreases; in the fourth region R4, the protrusion height of the asymmetric structure 2200 in the third direction gradually decreases to a substantially uniform height. Referring to FIG. 9B, in some embodiments, the asymmetric structure is a protrusion structure that is similar to a slide shape. In some embodiments, the maximum height H1 of the asymmetric structure does not overlap with the central axis C of the lens 200. In some embodiments, the highest point of the asymmetric structure does not overlap with the central axis C of the lens 200.

In some embodiments, the maximum height H1 of the asymmetric structure 2200 in the third direction is 0.88 mm. In some embodiments, the maximum height H1 of the asymmetric structure 2200 in the third direction is in a range of 0.5 mm to 2 mm.

Referring to FIG. 10, in some embodiments, when viewed from a top perspective, the asymmetric structure 2200 is symmetric in the second direction D2 and asymmetric in the first direction D1.

Referring to FIG. 10, in some embodiments, from a top perspective view, in the first region R1, the asymmetric structure 2200 has a first width W1, and the width of the asymmetric structure 2200 in the second direction D2 gradually increases along the first direction D1 to a second width W2, that is, in the first region R1, the width of the asymmetric structure 2200 in the second direction D2 increases from W1 to W2; in the second region R2, the width of the asymmetric structure 2200 in the second direction D2 is substantially uniform along the first direction D1, and the width of the asymmetric structure 2200 in the second direction D2 is the second width W2; in the third region R3, the width of the asymmetric structure 2200 in the second direction D2 is substantially uniform along the first direction D1, and the width of the asymmetric structure 2200 in the second direction D2 is the third width W3, wherein the second width W2 and the third width W3 are substantially equal; in the fourth region R4, the width of the asymmetric structure 2200 in the second direction D2 gradually decreases along the first direction D1 to the fourth width W4, that is, in the fourth region R4, the width of the asymmetric structure 2200 in the second direction D2 decreases from the third width W3 to the fourth width W4.

In some embodiments, the first width W1 ranges from 0.65 mm to 0.95 mm (millimeter, mm), the second width W2 ranges from 1.05 mm to 1.35 mm, the third width W3 ranges from 1.05 mm to 1.35 mm, and the fourth width W4 ranges from 0.65 mm to 0.95 mm. In some embodiments, the first width W1 is 0.80 mm, the second width W2 is 1.2 mm, the third width W3 is 1.2 mm, and the fourth width W4 is 0.8 mm.

In some embodiments, the asymmetric structure 2200 has an asymmetric structure length L when viewed from a top perspective view. The asymmetric structure length L ranges from 1.5 mm to 3.5 mm. In some embodiments, the asymmetric structure length L may be 2.38 mm.

FIG. 11 is a top view of the external structure of the lens according to some embodiments of the present disclosure, the light emitting surface 210 of the lens 200 is elliptical, and the lens base 230 is rectangular. In some embodiments, the lens base width WB is 2.5 mm to 4.5 mm. The lens base length LB is 2.5 mm to 4.5 mm. In some embodiments, the lens base width WB of the lens base 230 is 3.5 mm and the lens base length LB is 3.5 mm. In some embodiments, the major axis LA of the elliptical light emitting surface 210 may be 2 mm to 4 mm, and the minor axis SA of the elliptical light emitting surface 210 is 1.5 mm to 3.5 mm. In some embodiments, the major axis LA of the elliptical light emitting surface 210 is 3 mm and the minor axis SA is 2.52 mm.

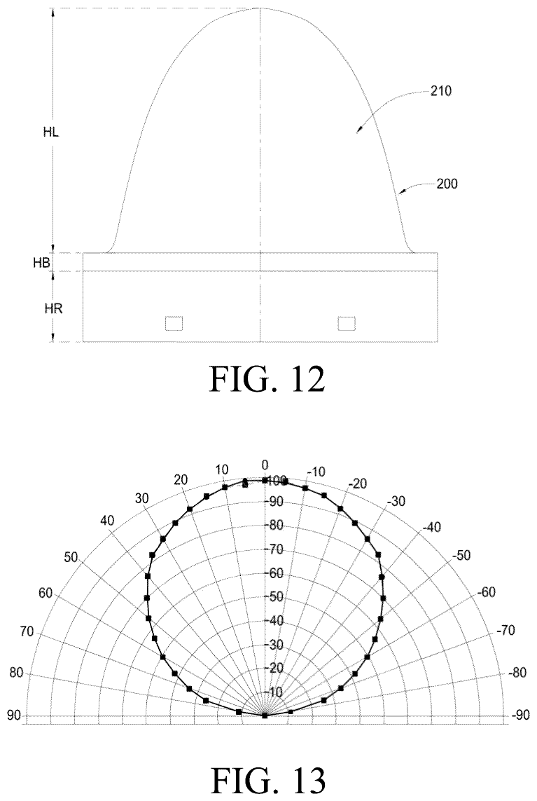

FIG. 12 is a side view of the external structure of the lens of the present disclosure. In some embodiments, the lens base height HB may be 0.15 mm to 0.25 mm. In some embodiments, the lens base height HB is 0.18 mm. In some embodiments, the light emitting surface height HL may be 1.5 mm to 3.5 mm. In some embodiments, the light emitting surface height HL may be 2.4 mm. In some embodiments, the resin package height HR is 0.7 mm.

In FIG. 13, a light distribution curve of a general light source (such as a light emitting diode) is shown. Generally, a light emitting diode has a Lambertian distribution.

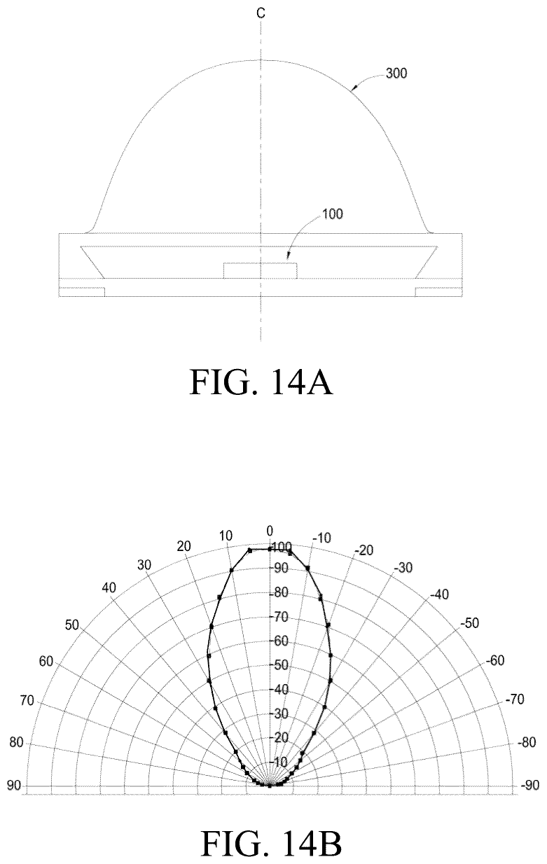

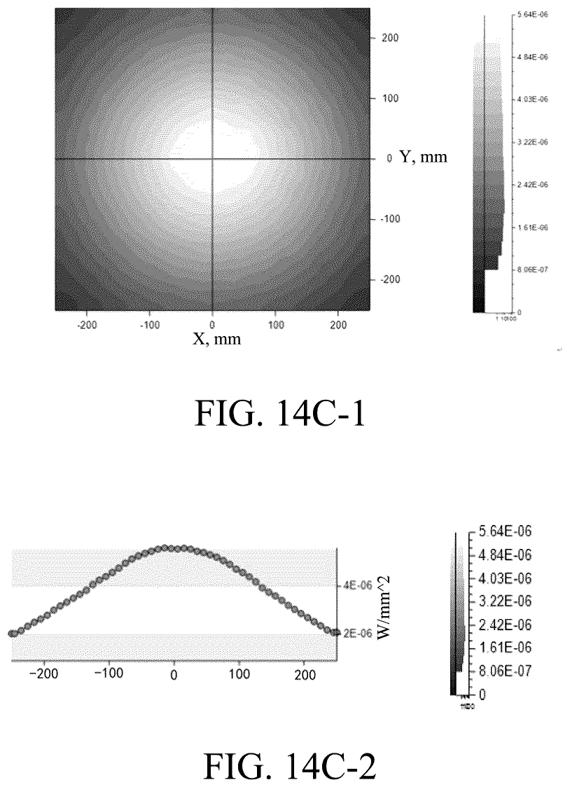

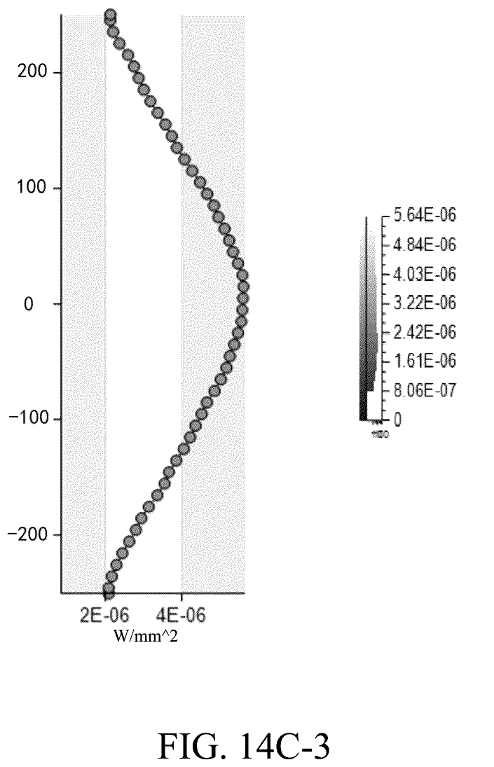

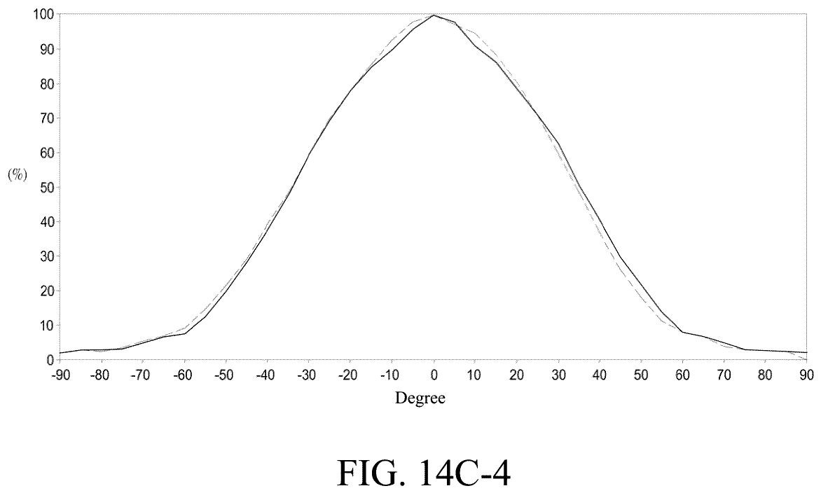

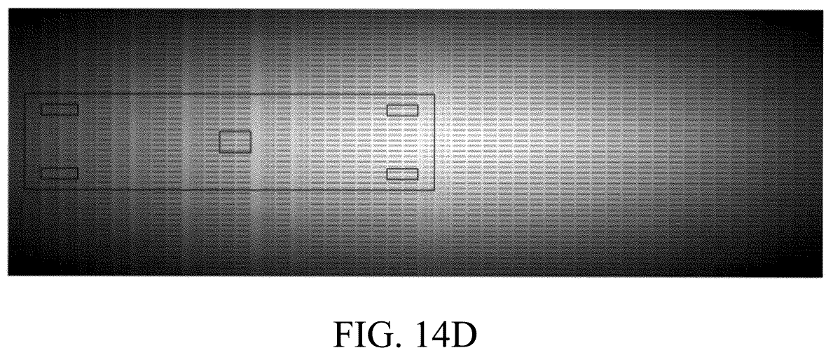

FIG. 14A is a schematic structural diagram of comparative example 1. In comparative example 1, a conventional lens 300 covers a light emitting element 100, and the light emitting element 100 is disposed on the central axis C of the conventional lens 300.

FIG. 14B is a light distribution curve of comparative example 1. Comparative example 1 may reduce the divergence angle, but it cannot produce the effect of deflecting the light at an angle.

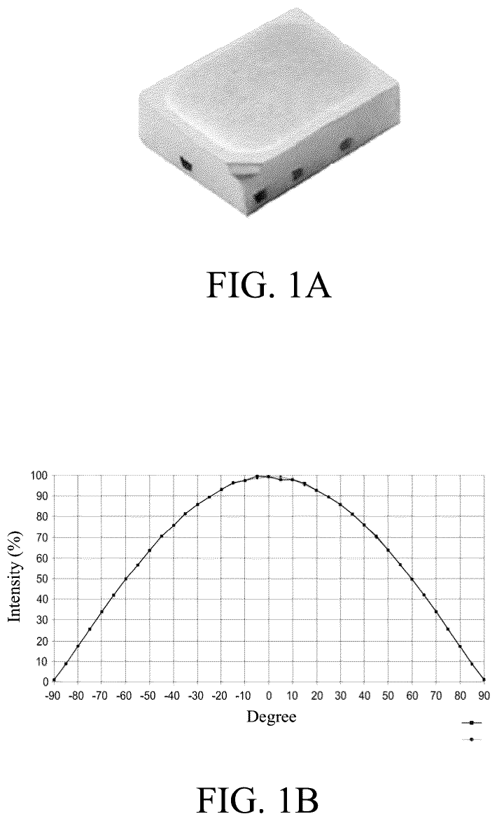

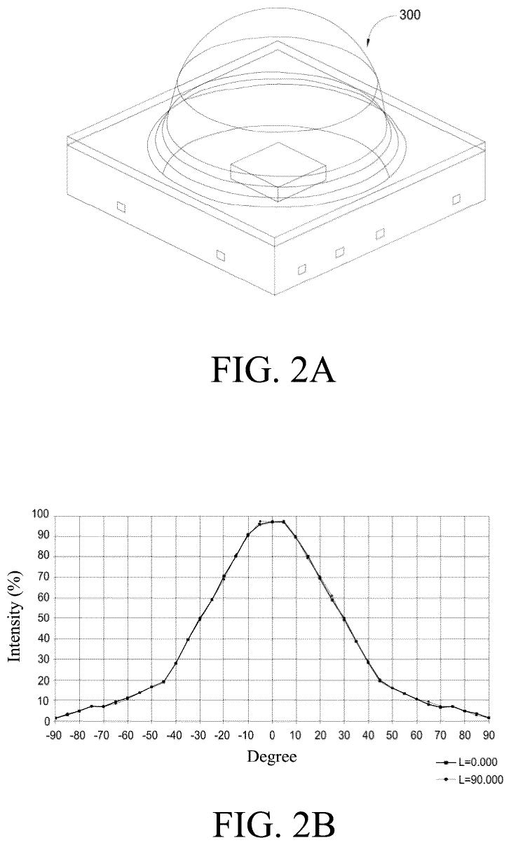

FIG. 14C-1 is the illumination distribution diagram of comparative example 1. The irradiance is still concentrated in the center (0,0) and is a circular light type. And, the light does not produce any deflection. FIG. 14C-2 is the illumination distribution diagram of the X-axis direction of comparative example 1. The maximum intensity of the irradiance is near the X-axis origin, and the irradiance gradually decreases away from the X-axis origin. FIG. 14C-3 is the illumination distribution diagram of the Y-axis direction of comparative example 1. The maximum intensity of the irradiance is near the Y-axis origin, and the irradiance gradually decreases away from the Y-axis origin. FIG. 14C-4 is the light angle distribution diagram of comparative example 1. The illumination percentage at the 0-degree position is 100%. In the direction of positive 90 degrees and minus 90 degrees, the illumination percentage becomes lower and lower, and the light does not produce any deflection.

In comparative example 1, the light pattern of the conventional lens 300 is circularly symmetrical. When the fatigue driving monitoring module is disposed on the A-pillar 21000 of the vehicle, the light on the left face of the driver may be insufficient, and a dark area can be generated in the corner of the light pattern, but the light on the right face may be overexposed, which is not good for the image capture unit 4000 (Camera sensor) to capture the driver's image. In addition, the light pattern of the conventional lens 300 does not have the effect of off-axis light. Therefore, when the fatigue driving monitoring module is set on the A-pillar 21000 of the vehicle, if it is not deviated, there can be a problem that the light filling for the driver's face cannot effectively cover the face.

In FIG. 14D, the relationship between the illumination distribution diagram of Example 1 and the facial illumination diagram is shown, and the rectangle represents the position of the driver's face. When the fatigue driving monitoring module is disposed on the A-pillar 21000 of the vehicle, since the light pattern of the conventional lens 300 is circularly symmetrical, the illumination is distributed and concentrated on the right side of the rectangle, that is, the light intensity near the right face of the driver is strong, while the light intensity near the left face of the driver is weak.

Table 1 is an intensity distribution analysis table of comparative example 1. From the values in Table 1, it may be seen that the light intensity distribution in the rectangle of comparative example 1 is uneven, and the light intensity is concentrated on the right side of the rectangle.

TABLE 1
Intensity distribution analysis table of comparative example 1.
Intensity (W/mm²)

| | | |
|---|---|---|
| Intensity of the upper left | | Intensity of the upper right |
| corner of the rectangle: | | corner of the rectangle: |
| 2.215 × 10⁻⁶ | | 5.100 × 10⁻⁶ |
| | Intensity in the center of | |
| | the rectangle: 4.14 × 10⁻⁶ | |
| Intensity of the lower left | | Intensity of the lower right |
| corner of the rectangle: | | corner of the rectangle: |
| 2.24 × 10⁻⁶ | | 5.00 × 10⁻⁶ |

Table 2 is a uniformity analysis table of comparative example 1. From the values in Table 2, it may be seen that the light intensity uniformity of comparative example 1 is not good, and it is too concentrated on the right side of the rectangle. That is, the light intensity near the right face of the driver is strong, while the light intensity near the left face of the driver is weak.

TABLE 2
Uniformity analysis table of comparative example 1.
Uniformity (%)

| | | |
|---|---|---|
| Uniformity of the upper | | Uniformity of the upper |
| left corner of the | | right corner of the |
| rectangle: 53.48% | | rectangle: 123.15% |
| | Uniformity of the center | |
| | of the rectangle: 100% | |
| Uniformity of the lower | | Uniformity of the lower |
| left | | right corner of the |
| corner | | rectangle: 120.74% |
| of the | | |
| rectangle: 54.17% | | |

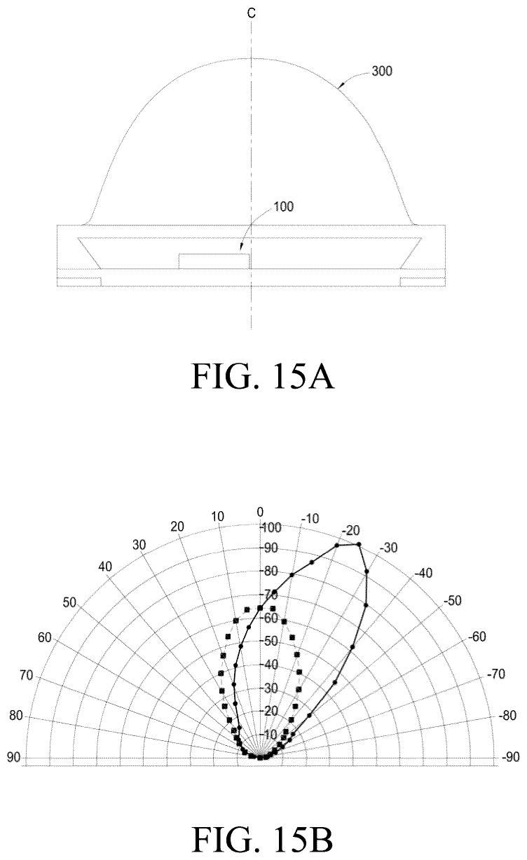

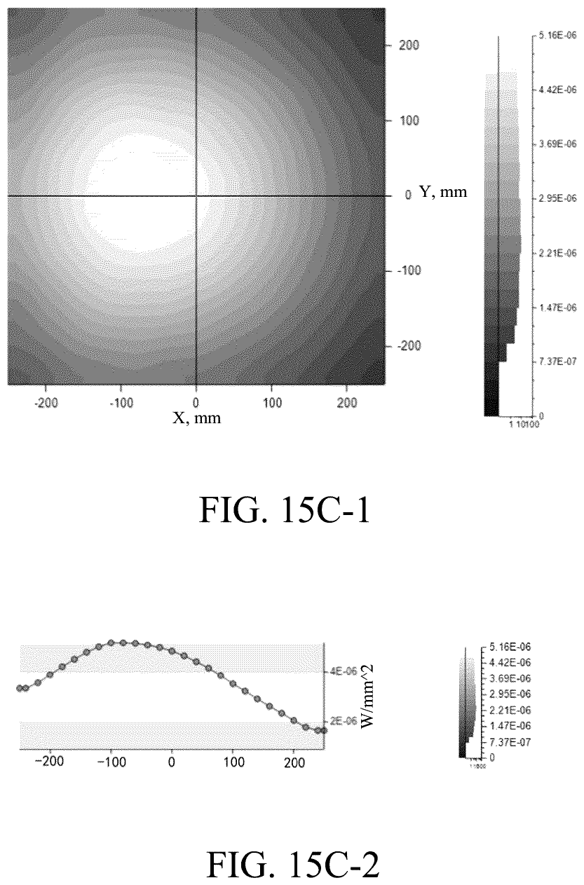

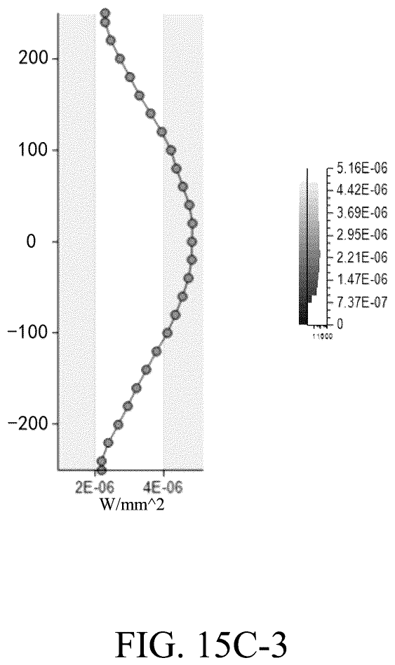

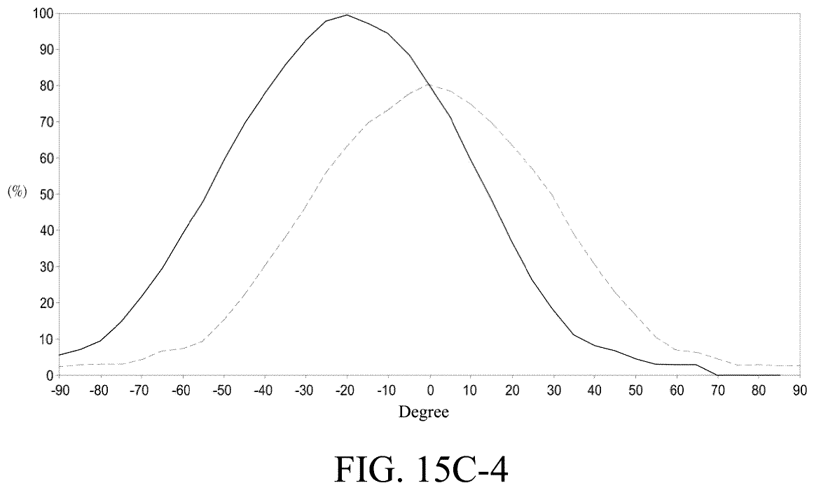

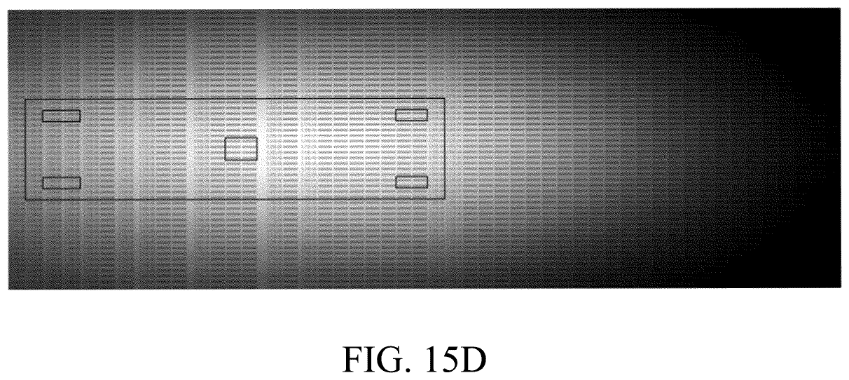

FIG. 15A is a schematic view of the structure of comparative example 2. In comparative example 2, the conventional lens 300 covers the light emitting element 100, and the light emitting element 100 is disposed at a position deviating from the central axis C of the conventional lens 300. Comparative example 2 can produce an angular deflection of the light pattern, but it cannot make the light pattern become a rectangular light.

FIG. 15B is a light distribution curve of comparative example 2. Comparative example 2 may reduce the divergence angle and make the light produce a deflection angle effect. The light in the X-axis direction has a deflection angle of minus 20 degrees to minus 30 degrees. Meanwhile, the light in the Y-axis direction is not deflected, and the comparative example 2 is still a circular light type.

FIG. 15C-1 is the illumination distribution diagram of comparative example 2. The highest irradiance is located at (−100, 0), that is, the light is deviated 100 mm in the negative direction of the X-axis, but the light in the Y-axis direction is not deviated. From the illumination distribution of comparative example 2, comparative example 2 is still a circular light type. FIG. 15C-2 is the illumination distribution diagram of comparative example 2 in the X-axis direction, and the maximum irradiance intensity is near 100 mm in the negative direction of the X-axis. FIG. 15C-3 is the illumination distribution diagram of comparative example 2 in the Y-axis direction, and the maximum irradiance intensity is near the origin of the Y-axis, and the irradiance gradually decreases away from the origin of the Y-axis. FIG. 15C-4 is the light angle distribution diagram of comparative example 2, and the light in the X-axis direction with an illumination percentage of 100% has a deflection angle of minus 20 degrees to minus 30 degrees. Meanwhile, the light in the Y-axis direction is not deflected.

FIG. 15D is the relationship between the illumination distribution diagram of comparative example 2 and the facial illumination diagram, and the rectangle represents the position of the driver's face. The fatigue driving monitoring module is disposed on the A-pillar 21000 of the vehicle. Comparative example 2 uses a conventional lens 300, so the light type is a circular light type, and the light emitting element 100 is disposed to be deviated from the central axis C of the conventional lens 300, so there is an effect of off-axis light. Although there is an effect of off-axis light, because it is a circularly symmetrical light type, it is still not enough to evenly supplement the light on the driver's face. In addition, since part of the light is irradiated on the face of the non-driver, the utilization efficiency of the light is relatively poor.

Table 3 is an intensity distribution analysis table of comparative example 2. From the values in Table 3, it may be seen that the light intensity distribution in the rectangle of comparative example 2 is uneven, the light intensity in the center of the rectangle is the strongest, the light intensity on the right side of the rectangle is the second strongest, and the light intensity on the left side of the rectangle is the lowest.

TABLE 3
Intensity distribution analysis table of comparative example 2.
Intensity (W/mm²)

| | | |
|---|---|---|
| Intensity of the upper left | | Intensity of the upper right |
| corner of the rectangle: | | corner of the rectangle: |
| 3.460 × 10⁻⁶ | | 4.687 × 10⁻⁶ |
| | Intensity in the center of | |
| | the rectangle: 5.255 × 10⁻⁶ | |
| Intensity at the lower left | | Intensity of the lower right |
| corner of the rectangle: | | corner of the rectangle: |
| 3.44 × 10⁻⁶ | | 4.67 × 10⁻⁶ |

Table 4 is a uniformity analysis table of comparative example 2. From the values in Table 4, it may be seen that the light intensity uniformity of comparative example 2 is not good, the uniformity is 100% in the center of the rectangle, but the uniformity of the light near the right face of the driver and the left face of the driver is different.

TABLE 4
Uniformity analysis table of comparative example 2.
Uniformity (%)

| | | |
|---|---|---|
| Uniformity of the upper | | Uniformity of the upper |
| left corner of the | | right corner of the |
| rectangle: 65.83% | | rectangle: 89.19% |
| | Uniformity of the center | |
| | of the rectangle: 100% | |
| Uniformity of the lower | | Uniformity of the lower |
| left corner of the | | right corner of the |
| rectangle: 65.38% | | rectangle: 88.90% |

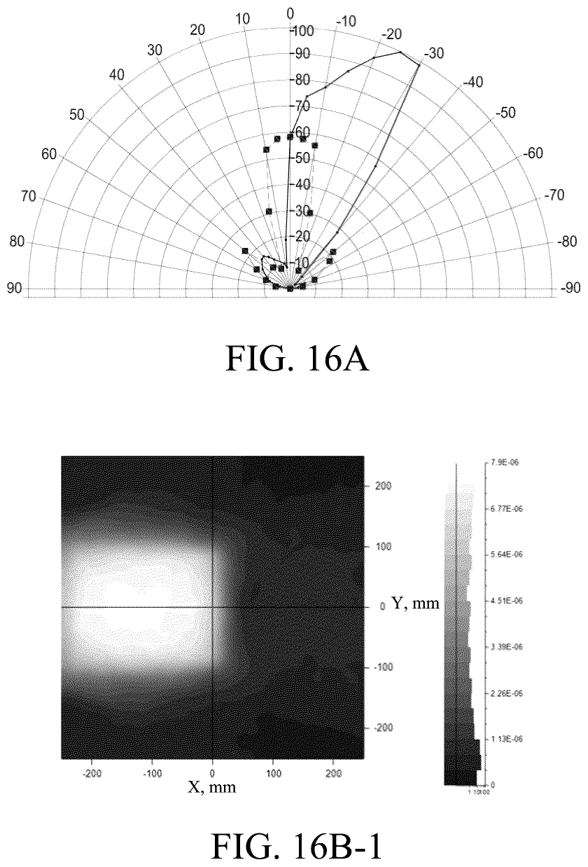

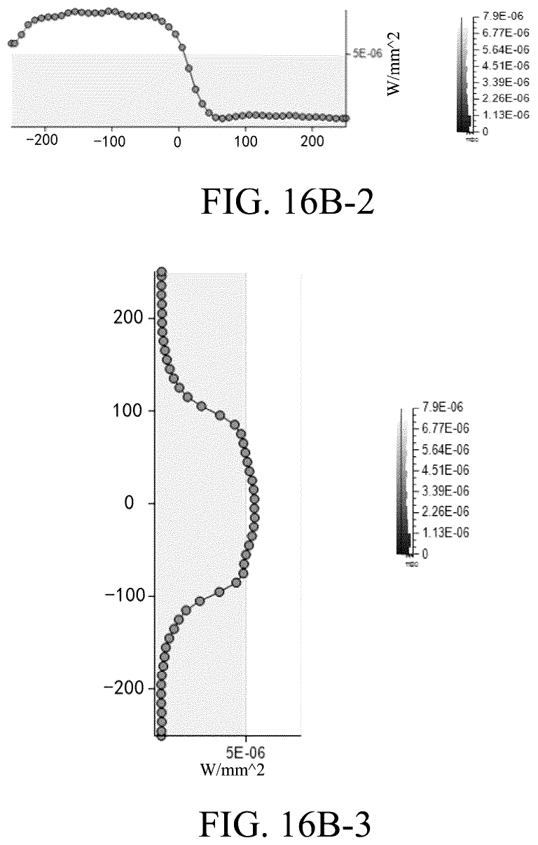

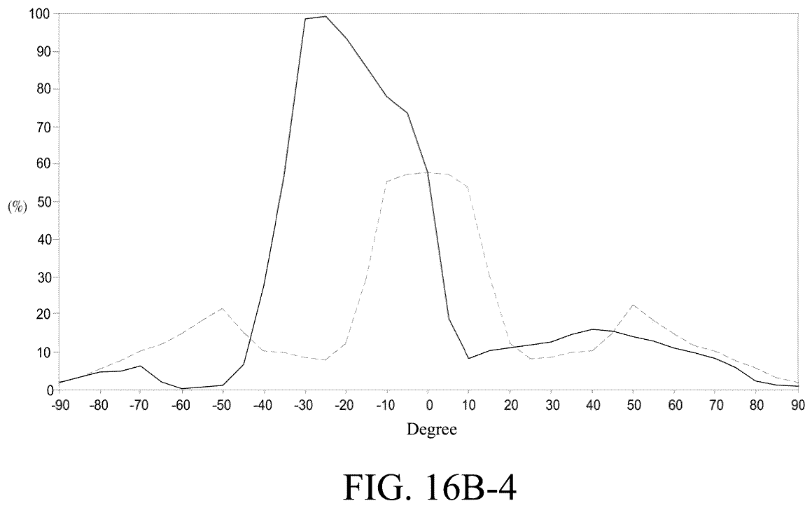

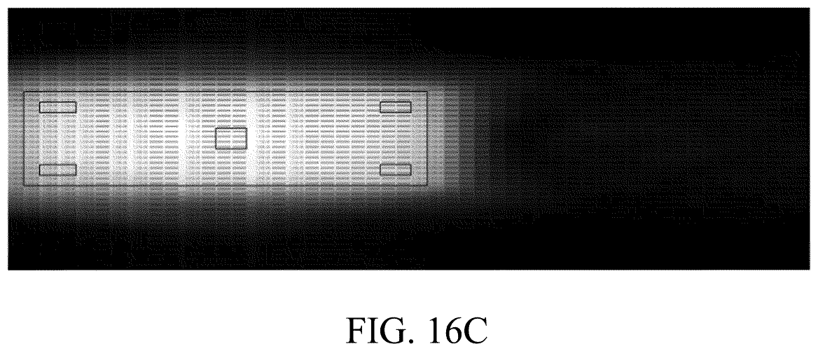

FIG. 16A shows the light distribution curves according to some embodiments of the present disclosure. In FIG. 8, the present disclosure uses the lens 200 including the light emitting surface 210 and the light entering surface 220, and the light entering surface 220 of the lens 200 has the asymmetric structure 2200. The lens 200 is disposed on the resin portion 12 of the resin package 10, and the light emitting element 100 is disposed deviated from the central axis C of the lens 200.

FIG. 16A is a light distribution curve according to some embodiments of the present disclosure. The maximum intensity in the Y-axis direction is reduced to 50% to 60%, and the deflected light is generated in the X-axis direction at about 20 degrees to 30 degrees and the intensity is 100% to generate deflection angle and rectangular light. That is, the present disclosure controls the deflection angle and rectangular light generated by the curvature of the asymmetric structure 2200 of the lens, and it controls the deflection of the light angle by disposing the light emitting element 100 deviating from the central axis C of the lens 200 to achieve maximum light energy utilization. Some embodiments of the present disclosure reduce the beam angle, deflect the angle at the same time, and form a rectangular light pattern, which may effectively utilize the light. Through the deflection angle, the image capture unit 4000 (Camera sensor) may obtain the improved image.

FIG. 16B-1 is an illumination distribution diagram of the present disclosure, it may be seen from the illumination distribution diagram that the light is a rectangular light, and the light will have a deviation of about 100 mm in the negative direction of the X-axis. Some embodiments of the present disclosure are rectangular lights with deviations. FIG. 16B-2 is an illumination distribution diagram of the present disclosure in the X-axis direction. At the position (0, 0), the irradiance is 5×10⁻⁶ (W/mm²). The irradiance is strongest near 10 mm to 200 mm in the negative direction of the X-axis, and the irradiance is weak near 50 mm to 250 mm in the positive direction of the X-axis. FIG. 16B-3 is an illumination distribution diagram of the Y-axis direction of comparative example 1. The irradiance is strongest near the origin of the Y-axis, and the irradiance gradually weakens away from the origin of the Y-axis. FIG. 16B-4 is a light angle distribution diagram of the present disclosure. When the illumination percentage is 100%, the light in the X-axis direction has a deflection angle of minus 20 degrees to minus 30 degrees. Meanwhile, the light in the Y-axis direction is not deflected, and at the 0 degree position, the illumination percentage is reduced to about 50% to 60%.

FIG. 16C is a diagram showing the relationship between the illumination distribution diagram of the present disclosure and the facial illumination diagram, and the rectangle represents the position of the driver's face. The fatigue driving monitoring module is disposed on the A-pillar 21000 of the vehicle. The present disclosure uses a lens 200, and the light entering surface 220 of the lens 200 has an asymmetric structure 2200, which generates rectangular light, so that the effective illumination area of the light may cover the driver's face, and thus the utilization efficiency of the light is good.

Table 5 is an intensity distribution analysis table of the present disclosure. It may be seen from the values in Table 5 that the light intensity distribution in the rectangle of the present disclosure is not much different, and the light intensity in the center of the rectangle, the intensity on the right side of the rectangle, and the intensity on the left side of the rectangle are not much different.

TABLE 5
Intensity distribution analysis table of the present disclosure.
Strength (W/mm²)

| | | |
|---|---|---|
| Intensity of the upper left | | Intensity of the upper right |
| corner of the rectangle: | | corner of the rectangle: |
| 6.551 × 10⁻⁶ | | 6.446 × 10-6 |
| | Intensity in the center of | |
| | the rectangle: 7.639 × 10⁻⁶ | |
| Intensity at the lower left | | Intensity of the lower right |
| corner of the rectangle: | | corner of the rectangle: |
| 6.40 × 10⁻⁶ | | 6.49 × 10⁻⁶ |

Table 6 is a uniformity analysis table of the present disclosure. From the values in Table 6, it may be seen that the light intensity uniformity of the present disclosure is better, and the uniformity is 100% in the center of the rectangle, with the uniformity of the light near the right face of the driver and the left face of the driver being similar.

TABLE 6
Uniformity analysis table of the present disclosure.
Uniformity (%)

| | | |
|---|---|---|
| Uniformity of the upper | | Uniformity of the upper |
| left corner of the | | right corner of the |
| rectangle: 85.77% | | rectangle: 84.39% |
| | Uniformity of the center | |
| | of the rectangle: 100% | |
| Uniformity of the lower | | Uniformity of the lower |
| left corner of the | | right corner of the |
| rectangle: 83.82% | | rectangle: 85.01% |

From Table 1, Table 3 and Table 5, the intensity of the present disclosure in the center of the rectangle is increased by 84.29% when compared with comparative example 1, the intensity of the present disclosure in the center of the rectangle is increased by 45.33% when compared with comparative example 2, the intensity of the present disclosure in the upper left corner of the rectangle is increased by 196% when compared with comparative example 1, the intensity of the present disclosure in the upper left corner of the rectangle is increased by 89.30% when compared with comparative example 2, the intensity of the present disclosure in the lower left corner of the rectangle is increased by 185% when compared with comparative example 1, and the intensity of the present disclosure in the lower left corner of the rectangle is increased by 86.04% when compared with comparative example 2.

From Table 2, Table 4 and Table 6, in terms of uniformity, the uniformity at the upper left corner of the rectangle must reach 80%. The uniformity at the upper left corner of the rectangle of the present disclosure is 32.29% higher than that of comparative example 1, the uniformity at the upper left corner of the rectangle of the present disclosure is 19.94% higher than that of comparative example 2, the uniformity at the lower left corner of the rectangle of the present disclosure is 29.65% higher than that of comparative example 1, and the uniformity at the lower left corner of the rectangle of the present disclosure is 18.44% higher than that of comparative example 2.

In addition, since the fatigue driving monitoring module is disposed on the A-pillar 21000 of the vehicle, if there is no light deviation, the driver's face can be filled with light but cannot be effectively covered. Therefore, when supplementing the light, the light needs to be deviated at a certain angle and the light shape needs to be formed into a rectangular light so that the effective irradiation area of the light may cover the driver's face.

The components among the embodiments of the present disclosure can be freely combined and used as long as they do not violate the spirit of the disclosure or conflict with each other. Furthermore, the scope of protection of the present disclosure is not limited to the manufacturing processes, machines, manufacturing, material compositions, devices, methods, and steps described in the specific embodiments within the specification. Any person skilled in the art can understand from the disclosures of the present disclosure the manufacturing processes, machines, manufacturing, material compositions, devices, methods, and steps developed currently or in the future. As long as they can perform substantially the same functions or achieve substantially the same results as implemented in the embodiments described herein, they can be used according to the present disclosure. Therefore, the scope of protection of the present disclosure includes the aforementioned manufacturing processes, machines, manufacturing, material compositions, devices, methods, and steps. Any embodiment or claim of the present disclosure does not need to achieve all the objectives, advantages, and/or features disclosed in the present disclosure.

What is claimed is:

1. An optical module, comprising:
a resin package, having a receiving groove;
a lens, disposed on the resin package, wherein the lens comprises a light emitting surface, a light entering surface and a central axis, wherein the light entering surface has an asymmetric structure; and
a light emitting element, disposed in the receiving groove, wherein the light emitting element is disposed deviated from the central axis of the lens.

2. The optical module as claimed in claim 1, wherein the asymmetric structure comprises a first region, a second region, a third region, and a fourth region.

3. The optical module as claimed in claim 1, wherein in a top perspective view, the asymmetric structure is symmetric in a second direction and asymmetric in a first direction.

4. The optical module as claimed in claim 2, wherein in a top perspective view, in the first region, the width of the asymmetric structure in the second direction gradually increases along the first direction; in the second region, the width of the asymmetric structure in the second direction is substantially uniform along the first direction; in the third region, the width of the asymmetric structure in the second direction is substantially uniform along the first direction; in the fourth region, the width of the asymmetric structure in the second direction gradually decreases along the first direction.

5. The optical module as claimed in claim 2, wherein in a cross-sectional view, in the first region, the asymmetric structure has a first curvature; in the second region, the asymmetric structure has a second curvature; in the third region, the asymmetric structure has a third curvature; and in the fourth region, the asymmetric structure has a fourth curvature.

6. The optical module as claimed in claim 5, wherein in the cross-sectional view, in the first region, the asymmetric structure is a convex surface; in the second region, the asymmetric structure is a convex surface; in the third region, the asymmetric structure is a concave surface; in the fourth region, the asymmetric structure is a concave surface.

7. The optical module as claimed in claim 1, wherein in a cross-sectional view, along the first direction, a protrusion height of the asymmetric structure of the light entering surface in a third direction is non-uniform.

8. The optical module as claimed in claim 5, wherein in the cross-sectional view, along the first direction, in the first region, the protrusion height of the asymmetric structure in the third direction gradually increases; in the middle position of the second region, the protrusion height of the asymmetric structure in the third direction reaches the maximum height of the asymmetric structure; in the third region, the protrusion height of the asymmetric structure in the third direction gradually decreases.

9. The optical module as claimed in claim 1, wherein in a cross-sectional view, the asymmetric structure is a convex structure that is similar to a slide shape.

10. The optical module as claimed in claim 8, wherein in the cross-sectional view, a highest point of the asymmetric structure does not overlap with the central axis of the lens.
